(19) United States
(12) Patent Application Publication
(10) Pub. No.: US 2026/0118574 A1
(43) Pub. Date: Apr. 30, 2026

(54) OPTICAL FIBER

(71) Applicant: SUMITOMO ELECTRIC INDUSTRIES, LTD., Osaka (JP)

(72) Inventors: Noriaki IWAGUCHI, Osaka (JP); Katsushi HAMAKUBO, Osaka (JP); Tatsuya KONISHI, Osaka (JP)

(21) Appl. No.: 19/351,374

(22) Filed: Oct. 7, 2025

(30) Foreign Application Priority Data
Oct. 30, 2024 (JP) 2024-190560

(51) Int. Cl. G02B 6/02

(52) U.S. Cl. CPC G02B 6/02395

(57) ABSTRACT

An optical fiber according to the present disclosure includes a glass fiber including a core and a cladding, and a coating resin layer being in contact with the glass fiber and coating the glass fiber. The cladding includes an inner cladding covering an outer periphery of the core, a trench covering an outer periphery of the inner cladding, and an outer cladding covering an outer periphery of the trench. The coating resin layer includes a primary resin layer coating the glass fiber and a secondary resin layer coating the primary resin layer. The outer cladding includes quartz glass doped with chlorine, and an average chlorine mass concentration in the outer cladding is 100 ppm or more and 6000 ppm or less.

### CROSS REFERENCE TO RELATED APPLICATIONS

This application claims priority based on Japanese Patent Application No. 2024-190560 filed on Oct. 30, 2024, and the entire contents of the Japanese patent application are incorporated herein by reference.

### TECHNICAL FIELD

The present disclosure relates to an optical fiber.

### BACKGROUND

In recent years, there has been an increasing demand for a high-density cable in which the packing density of optical fibers is increased. In order to increase the packing density of optical fibers in a cable, it is advantageous to reduce the outer diameters of the optical fibers. When the outer diameter of the optical fiber is reduced, the bending characteristic of the optical fiber tends to be lowered.

The optical fiber includes a glass fiber as an optical transmission medium and a coating resin layer for protecting the glass fiber. The coating resin layer includes, for example, a primary resin layer in contact with the glass fiber and a secondary resin layer formed on an outer peripheral surface of the primary resin layer.

In order to improve the bending characteristics, it has been studied to decrease a Young's modulus of the primary resin layer or to increase a Young's modulus of the secondary resin layer. For example, in JP 2012-111674 A, achievement of both softness (low Young's modulus) and mechanical strength of a primary resin layer has been investigated using a resin composition containing a urethane oligomer obtained by reacting a reaction product of an aliphatic polyether diol and a diisocyanate with a monohydric alcohol and a hydroxyl group-containing (meth)acrylate.

### SUMMARY

An optical fiber according to one aspect of the present disclosure includes a glass fiber including a core and a cladding, and a coating resin layer being in contact with the glass fiber and coating the glass fiber. The cladding includes an inner cladding covering an outer periphery of the core, a trench covering an outer periphery of the inner cladding, and an outer cladding covering an outer periphery of the trench. The coating resin layer includes a primary resin layer coating the glass fiber and a secondary resin layer coating the primary resin layer. The outer cladding includes quartz glass doped with chlorine, and an average chlorine mass concentration in the outer cladding is 100 ppm or more and 6000 ppm or less.

### BRIEF DESCRIPTION OF THE DRAWINGS

FIG. 1 is a schematic cross-sectional view showing an example of an optical fiber according to an embodiment.

### DETAILED DESCRIPTION

An optical fiber is required to have maintained properties such as tensile strength even in the case of being immersed in water for a long term. However, an optical fiber including a primary resin layer having low Young's modulus in order to improve the bending characteristics tends to have a low degree of curing, and when the optical fiber is immersed in hot water, the coating resin layer may peel off from the glass fiber, resulting in a decrease in the tensile strength of the optical fiber.

An object of the present disclosure is to provide an optical fiber having excellent bending resistance and hot water resistance, and capable of maintaining tensile strength even when immersed in water for a long time.

### DESCRIPTION OF EMBODIMENTS OF PRESENT DISCLOSURE

First, the contents of the embodiments of the present disclosure will be listed and described.

(1) An optical fiber according to one aspect of the present disclosure includes a glass fiber including a core and a cladding, and a coating resin layer being in contact with the glass fiber and coating the glass fiber. The cladding includes an inner cladding covering an outer periphery of the core, a trench covering an outer periphery of the inner cladding, and an outer cladding covering an outer periphery of the trench. The coating resin layer includes a primary resin layer coating the glass fiber and a secondary resin layer coating the primary resin layer. The outer cladding includes quartz glass doped with chlorine, and an average chlorine mass concentration in the outer cladding is 100 ppm or more and 6000 ppm or less.

In such an optical fiber, a specific amount of chlorine is added to the outer cladding, so that a trace amount of acidic components is generated from the glass fiber when the optical fiber is immersed in water, and the bonding between the glass fiber and the primary resin layer can be maintained even during immersion in hot water, and the tensile strength can be maintained even when immersed in water for a long time.

(2) In the above (1), from the viewpoint of further improving the hot water resistance, the coating resin layer may include a cured product of a resin composition containing acylphosphine oxide-based photopolymerization initiator and photopolymerizable compound including urethane (meth)acrylate, and a content of the phosphine oxide-based photopolymerization initiator remaining in the coating resin layer may be 0.3% by mass or less with respect to a total amount of the optical fiber.

(3) In the above (1) or (2), from the viewpoint of further improving the hot water resistance, the primary resin layer may include a cured product of a resin composition containing an acylphosphine oxide-based photopolymerization initiator, a silane coupling agent, an organic base, and a photopolymerizable compound including urethane (meth)acrylate.

(4) In the above (3), from the viewpoint of improving storage stability, the organic base may be δ-valerolactam or ε-caprolactam.

(5) In any one of the above (1) to (4), from the viewpoint of excellent lateral pressure characteristics, the primary resin layer may have a Young's modulus of 0.6 MPa or less at 23° C.

### DETAILS OF EMBODIMENTS OF PRESENT DISCLOSURE

Specific examples of an optical fiber according to embodiments of the present disclosure will be described with reference to the drawings. It should be noted that the present disclosure is not limited to these examples, but is defined by the scope of the claims and is intended to include all modifications within the meaning and scope equivalent to the scope of the claims. In the following description, the same elements are denoted by the same reference numerals in the description of the drawings, and redundant description is omitted. In the present embodiment, the term “(meth)acrylate” means acrylate or methacrylate corresponding thereto, and the same also applies to other similar expressions such as (meth)acrylic acid. In the present specification, ppm represents a mass ratio.

### (Optical Fiber)

An optical fiber according to the embodiment includes a glass fiber including a core and a cladding, and a coating resin layer being in contact with the glass fiber and coating the glass fiber. The cladding includes an inner cladding covering an outer periphery of the core, a trench covering an outer periphery of the inner cladding, and an outer cladding covering an outer periphery of the trench. The coating resin layer includes a primary resin layer coating the glass fiber and a secondary resin layer coating the primary resin layer. The outer cladding includes quartz glass doped with chlorine, and an average chlorine mass concentration in the outer cladding is 100 ppm or more and 6000 ppm or less.

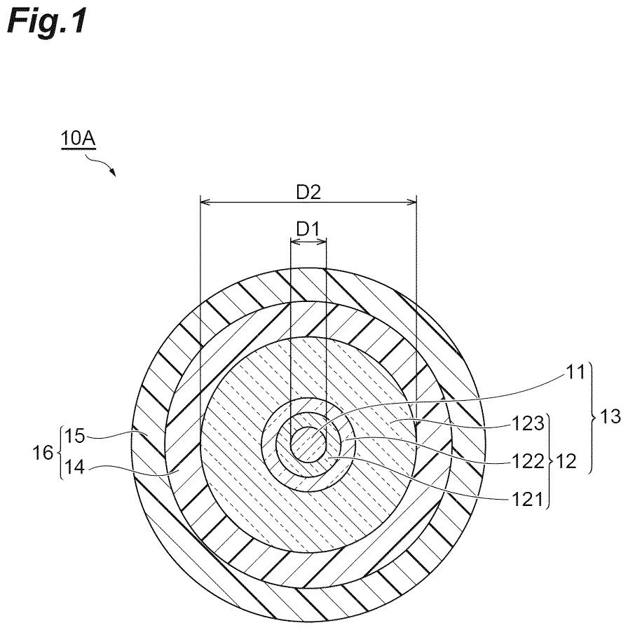

FIG. 1 is a schematic cross-sectional view showing an example of an optical fiber according to an embodiment. A optical fiber 10A includes a glass fiber 13 including a core 11 and a cladding 12, and a coating resin layer 16 including a secondary resin layer 15 and a primary resin layer 14 provided on an outer periphery of the glass fiber 13. In the optical fiber 10A, the cladding 12 includes an inner cladding 121 that covers an outer periphery of the core 11 and is in contact with the outer peripheral surface of the core 11, a trench 122 that covers an outer periphery of the inner cladding 121 and is in contact with the outer peripheral surface of the inner cladding 121, and an outer cladding 123 that covers an outer periphery of the trench 122 and is in contact with the outer peripheral surface of the trench 122.

The core 11 and the cladding 12 mainly include glass such as quartz glass. Pure quartz glass or quartz glass doped with germanium can be used for the core 11. Pure quartz glass, quartz glass doped with fluorine, or quartz glass doped with chlorine can be used for the inner cladding 121. From the viewpoint of hot water resistance characteristics, the inner cladding 121 may include quartz glass doped with chlorine, and an average chlorine mass concentration in the inner cladding 121 may be, for example, 500 ppm or more and 5000 ppm or less, or 500 ppm or more and 3000 ppm or less. Quartz glass doped with fluorine can be used for the trench 122.

From the viewpoint of maintaining the tensile strength even when the optical fiber is immersed in water for a long time, quartz glass doped with chlorine can be used for the outer cladding 123. An average chlorine mass concentration in the outer cladding 123 is 100 ppm or more and 6000 ppm or less, and from the viewpoint of further enhancing the glass tensile strength when the optical fiber is immersed in water for a long time, it may be 200 ppm or more and 5500 ppm or less, 300 ppm or more and 5300 ppm or less, 400 ppm or more and 5000 ppm or less, 450 ppm or more and 4000 ppm or less, or 480 ppm or more and 3500 ppm or less. An average OH mass concentration in the outer cladding 123 is substantially zero. Here, “substantially zero” specifically means 50 ppm or less.

In FIG. 1, for example, an outer diameter (D2) of the glass fiber 13 may be 100 μm or more and 125 μm or less, and a diameter (D1) of the core 11 constituting the glass fiber 13 may be 7 μm or more and 15 μm or less. A thickness of the coating resin layer 16 may be, for example, 22 μm or more and 70 μm or less. A thickness of each of the primary resin layer 14 and the secondary resin layer 15 may be 5 μm or more and 50 μm or less.

The outer diameter (D2) of the glass fiber 13 may be 125 μm or more and 220 μm or less, 150 μm or more and 210 μm or less, or 170 μm or more and 190 μm or less. An outer diameter of the optical fiber 10A may be 200 μm or more and 250 μm or less, 210 μm or more and 240 μm or less, or 220 μm or more and 230 μm or less.

The coating resin layer 16 may include a cured product of a resin composition containing a photopolymerizable compound and an acylphosphine oxide-based photopolymerization initiator, and a content of the phosphine oxide-based photopolymerization initiator remaining in the coating resin layer 16 may be 0.3% by mass or less with respect to a total amount of the optical fiber. Thus, an optical fiber with reduced change in adhesion over time can be obtained.

A content of the acylphosphine oxide-based photopolymerization initiator in the optical fiber can be adjusted by changing the amount of the acylphosphine oxide-based photopolymerization initiator blended in the resin composition used for forming the coating resin layer, the production speed when producing the optical fiber, the time until additional irradiation with ultraviolet light after producing the optical fiber, and the like.

Examples of the acylphosphine oxide-based photopolymerization initiator include 2,4,6-trimethylbenzoyl diphenylphosphine oxide (Omnirad TPO N, manufactured by IGM Resins B.V.), ethyl(2,4,6-trimethylbenzoyl)-phenyl phosphinate (Omnirad TPO-L, manufactured by IGM Resins B.V.), bis(2,4,6-trimethylbenzoyl)phenylphosphine oxide (Omnirad 819, manufactured by IGM Resins B.V.), and bis(2,6-dimethoxybenzoyl)-2,4,4-trimethylpentylphosphine oxide.

When the acylphosphine oxide-based photopolymerization initiator remains in the coating resin layer, the acylphosphine oxide-based photopolymerization initiator aggregates and may serve as a starting point of interfacial peeling between the glass fiber 13 and the coating resin layer 16, and thus the residual amount is preferably small. A content of the acylphosphine oxide-based photopolymerization initiator remaining in the coating resin layer may be 0.3% by mass or less, 0.2% by mass or less, or 0.1% by mass or less from the viewpoint of enhancing the adhesion between the glass fiber and the coating resin layer.

The resin composition according to the present embodiment may further contain another photopolymerization initiator different from the acylphosphine oxide-based photopolymerization initiator. Another photopolymerization initiator can be appropriately selected from known radical photopolymerization initiators and used. Examples of another photopolymerization initiator include 1-hydroxycyclohexyl phenyl ketone (Omnirad 184, manufactured by IGM Resins B.V.), 2,2-dimethoxy-2-phenyl acetophenone (Omnirad 651, manufactured by IGM Resins B.V.), 1-(4-isopropylphenyl)-2-hydroxy-2-methylpropan-1-one, and 2-methyl-1-[4-(methylthio)phenyl]-2-morpholino-propan-1-one (Omnirad 907, manufactured by IGM Resins B.V.).

A content of the photopolymerization initiator in the resin composition may be 1 part by mass or more and 10 parts by mass or less, 2 parts by mass or more and 8 parts by mass or less, or 3 parts by mass or more and 7 parts by mass or less, with respect to 100 parts by mass of the total amount of the photopolymerizable compound. The content of the photopolymerization initiator may be 0.2 parts by mass or more, 0.4 parts by mass or more, or 0.6 parts by mass or more, and may be 6 parts by mass or less, 5 parts by mass or less, or 4 parts by mass or less, with respect to 100 parts by mass of the total amount of the photopolymerizable compound.

The photopolymerizable compound may include urethane (meth)acrylate from the viewpoint of adjusting the Young's modulus of the coating resin layer. As the urethane (meth)acrylate, for example, a reaction product with a polyol compound, a polyisocyanate compound, and a hydroxyl group-containing (meth)acrylate compound can be used. The urethane (meth)acrylate may be used alone or in combination of two or more kinds thereof.

Examples of the polyol compound include polytetramethylene glycol, polypropylene glycol, and bisphenol A-ethylene oxide adduct diol. Examples of the polyisocyanate compound include 2,4-tolylene diisocyanate, 2,6-tolylene diisocyanate, isophorone diisocyanate, and dicyclohexylmethane 4,4′-diisocyanate. Examples of the hydroxyl group-containing (meth)acrylate compound include 2-hydroxyethyl (meth)acrylate, 2-hydroxybutyl (meth)acrylate, 1,6-hexanediol mono(meth)acrylate, pentaerythritol tri(meth)acrylate, 2-hydroxypropyl (meth)acrylate, and tripropylene glycol mono(meth)acrylate.

From the viewpoint of adjusting the Young's modulus of the primary resin layer, a number-average molecular weight (Mn) of the polyol compound may be 1000 or more and 10000 or less, 1500 or more and 9000 or less, 2000 or more and 8000 or less, or 3000 or more and 6000 or less. From the viewpoint of adjusting the Young's modulus of the secondary resin layer, the Mn of the polyol compound may be 300 or more and 3000 or less, 400 or more and 2500 or less, or 500 or more and 2000 or less.

As a catalyst for synthesizing the urethane (meth)acrylate, an organotin compound is generally used. Examples of the organotin compound include dibutyltin dilaurate, dibutyltin diacetate, dibutyltin maleate, dibutyltin bis (2-ethylhexyl mercaptoacetate), dibutyltin bis (isooctyl mercaptoacetate), and dibutyltin oxide. From the viewpoint of easy availability or catalyst performance, dibutyltin dilaurate or dibutyltin diacetate may be used as the catalyst.

When the urethane (meth)acrylate is synthesized, lower alcohol having five or less carbon atoms may be used. Examples of the lower alcohol include methanol, ethanol, 1-propanol, 2-propanol, 1-butanol, 2-butanol, 2-methyl-2-propanol, 1-pentanol, 2-pentanol, 3-pentanol, 2-methyl-1-butanol, 3-methyl-1-butanol, 2-methyl-2-butanol, 3-methyl-2-butanol, and 2,2-dimethyl-1-propanol.

The photopolymerizable compound according to the embodiment may further include a photopolymerizable compound (hereinafter, referred to as “monomer”) other than the urethane (meth)acrylate.

Examples of the monomer include monofunctional monomers having one polymerizable group and polyfunctional monomers having two or more polymerizable groups. A mixture of two or more monomers may be used.

Examples of monofunctional monomer include (meth)acrylate monomers such as methyl (meth)acrylate, ethyl (meth)acrylate, propyl (meth)acrylate, n-butyl (meth)acrylate, s-butyl (meth)acrylate, tert-butyl (meth)acrylate, isobutyl (meth)acrylate, n-pentyl (meth)acrylate, isopentyl (meth)acrylate, hexyl (meth)acrylate, heptyl (meth)acrylate, isoamyl (meth)acrylate, 2-ethylhexyl (meth)acrylate, n-octyl (meth)acrylate, isooctyl (meth)acrylate, isodecyl (meth)acrylate, lauryl (meth)acrylate, 2-phenoxyethyl (meth)acrylate, 3-phenoxybenzyl acrylate, phenoxydiethylene glycol acrylate, phenoxy polyethylene glycol acrylate, 4-tert-butylcyclohexanol acrylate, tetrahydrofurfuryl (meth)acrylate, benzyl (meth)acrylate, dicyclopentenyl (meth)acrylate, dicyclopentenyloxyethyl (meth)acrylate, dicyclopentanyl (meth)acrylate, nonylphenol polyethylene glycol (meth)acrylate, nonylphenoxy polyethylene glycol (meth)acrylate, 2-hydroxyethyl (meth)acrylate, nonylphenol ethylene oxide-modified (meth)acrylate, tricyclodecanyl (meth)acrylate, polypropyleneglycol mono(meth)acrylate, and isobornyl (meth)acrylate; carboxy group-containing monomers such as (meth)acrylic acid, (meth)acrylic acid dimer, carboxyethyl (meth)acrylate, carboxypentyl (meth)acrylate, and ω-carboxypolycaprolactone (meth)acrylate; heterocyclic ring-containing monomers such as N-vinylpyrrolidone, N-vinyl caprolactam, N-(meth)acryloyl morpholine, N-(meth)acryloyl piperidine, N-(meth)acryloyl pyrrolidine, 3-(3-pyridine)propyl (meth)acrylate, and cyclic trimethylolpropane formal acrylate; maleimide-based monomers such as maleimide, N-cyclohexyl maleimide, and N-phenylmaleimide; amide-based monomers such as (meth)acrylamide, N,N-dimethyl (meth)acrylamide, N,N-diethyl (meth)acrylamide, N-hexyl (meth)acrylamide, N-methyl (meth)acrylamide, N-ethyl (meth)acrylamide, N-butyl (meth)acrylamide, N-methylol (meth)acrylamide, and N-methylolpropane (meth)acrylamide; aminoalkyl (meth)acrylate monomers such as aminoethyl (meth)acrylate, aminopropyl (meth)acrylate, N,N-dimethylaminoethyl (meth)acrylate, and tert-butylaminoethyl (meth)acrylate; and succinimide monomers such as N-(meth)acryloyl oxymethylene succinimide, N-(meth)acryloyl-6-oxyhexamethylene succinimide, and N-(meth)acryloyl-8-oxyoctamethylene succinimide.

From the viewpoint of excellent copolymerizability with other monomers and improvement in curing rate, an N-vinyl monomer having a cyclic structure may be used as the monofunctional monomer. A content of the N-vinyl monomer may be 1 part by mass or more and 15 parts by mass or less, or 2 parts by mass or more and 10 parts by mass or less, with respect to 100 parts by mass of the total amount of the resin composition.

Examples of the polyfunctional monomer include polyethylene glycol di(meth)acrylate, tricyclodecanediyldimethylene di(meth)acrylate, isocyanuric acid ethylene oxide-modified di(meth)acrylate, ethylene oxide-modified bisphenol F di(meth)acrylate, ethylene oxide-modified bisphenol A di(meth)acrylate, polypropylene glycol di(meth)acrylate, propylene oxide-modified bisphenol A di(meth)acrylate, propylene oxide-modified neopentyl glycol di(meth)acrylate, polytetraethylene glycol di(meth)acrylate, hydroxypivalate neopentyl glycol di(meth)acrylate, 1,4-butanediol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, neopentyl glycol di(meth)acrylate, isopentyldiol di(meth)acrylate, 3-ethyl-1,8-octanediol di(meth)acrylate; trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxy polypropoxy tri(meth)acrylate, tris[(meth)acryloyloxyethyl] isocyanurate, pentaerythritol tri(meth)acrylate, pentaerythritol polyethoxy tetra(meth)acrylate, pentaerythritol polypropoxy tetra(meth)acrylate, pentaerythritol tetra(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, and caprolactone-modified tris[(meth)acryloyloxyethyl] isocyanurate.

The photopolymerizable compound may include a polyfunctional monomer modified with alkylene oxide from the viewpoint of adjusting the Young's modulus of the primary resin layer. The polyfunctional monomer modified with alkylene oxide may have at least one selected from the group consisting of an ethylene oxide (EO) chain and a propylene oxide (PO) chain. The ethylene oxide chain can be represented by “(EO)n”, and the propylene oxide chain can be represented by “(PO)n”. The “n” is an integer of 1 or more, may be 2 or more or 3 or more, and may be 30 or less, 25 or less, or 20 or less.

Examples of alkylene oxide-modified di(meth)acrylate include polyethylene glycol di(meth)acrylate, isocyanuric acid ethylene oxide-modified di(meth)acrylate, ethylene oxide-modified bisphenol F di(meth)acrylate, ethylene oxide-modified bisphenol A di(meth)acrylate, polypropylene glycol di(meth)acrylate, propylene oxide-modified bisphenol A di(meth)acrylate, and propylene oxide-modified neopentyl glycol di(meth)acrylate.

The primary resin layer 14 may be formed using a UV-curable resin composition containing a photopolymerizable compound including urethane (meth)acrylate, an acylphosphine oxide-based photopolymerization initiator, a silane coupling agent, and organic base.

From the viewpoint of adjusting the Young's modulus of the primary resin layer, a content of the urethane (meth)acrylate may be 15 parts by mass or more and 80 parts by mass or less, 20 parts by mass or more and 70 parts by mass or less, or 30 parts by mass or more and 60 parts by mass, or less with respect to 100 parts by mass of the total amount of the resin composition.

The resin composition may contain a trace amount of an acid component such as acrylic acid derived from the photopolymerizable compound. The silane coupling agent is hydrolyzed and deactivated by the acid component, and the resin composition may change with time. In contrast, the resin composition according to the embodiment contains the organic base, and thus, the acid component can be neutralized to suppress the deactivation of the silane coupling agent, and thus, an optical fiber having excellent hot water resistance even after a certain time has elapsed from the resin production can be produced. Such an effect is enhanced particularly when the Young's modulus of the primary resin layer is low.

As the organic base, an amine compound or an amide compound may be used. Examples of the amine compound include aromatic amines such as aniline, aliphatic amines having an aromatic ring such as benzylamine, and heterocyclic amines such as pyrrolidine, piperidine, and pyridine. Examples of the amide compound include cyclic amides such as δ-valerolactam and ε-caprolactam.

Basic components are generally known to corrode glass. When the molecular structure of the basic component is large, the corrosion reaction of the glass is less likely to occur due to the steric hindrance thereof, and thus, the organic base may be an aromatic amine, an aliphatic amine having an aromatic ring, a heterocyclic amine, or a cyclic amide. From the viewpoint of suppressing deactivation of the silane coupling agent in the resin composition, a heterocyclic amine or a cyclic amide may be used as the organic base. From the viewpoint of further improving the hot water resistance, δ-valerolactam or ε-caprolactam may be used as the organic base.

A content of the organic base may be 5 ppm or more and 9000 ppm or less with respect to a total amount of the coating resin layer from the viewpoint of improving the hot water resistance. A content of the organic base may be 8 ppm or more, 10 ppm or more, 100 ppm or more, 500 ppm or more, 800 ppm or more, or 1000 ppm or more, with respect to the total amount of the coating resin layer from the viewpoint of suppressing the deactivation of the silane coupling agent, and may be 8500 ppm or less, 8000 ppm or less, 7000 ppm or less, 6000 ppm or less, or 5000 ppm or less from the viewpoint of suppressing the corrosion of glass.

The silane coupling agent is not particularly limited as long as it does not hinder the curing of the resin composition. Examples of the silane coupling agent include tetramethyl silicate, tetraethyl silicate, mercaptopropyl trimethoxysilane, vinyltrichlorosilane, vinyltriethoxysilane, vinyltris(β-methoxy-ethoxy)silane, β-(3,4-epoxycyclohexyl)-ethyltrimethoxysilane, dimethoxydimethylsilane, diethoxydimethylsilane, 3-acryloxypropyl trimethoxysilane, γ-glycidoxypropyltrimethoxysilane, γ-glycidoxypropylmethyldiethoxysilane, γ-methacryloxypropyltrimethoxysilane, N-(D-aminoethyl)-γ-aminopropyltrimethoxysilane, N-(D-aminoethyl)-γ-aminopropyltrimethyldimethoxysilane, N-phenyl-γ-aminopropyltrimethoxysilane, γ-chloropropyltrimethoxysilane, γ-mercaptopropyltrimethoxysilane, γ-aminopropyltrimethoxysilane, bis[3-(triethoxysilyl) propyl]tetrasulfide, bis[3-(triethoxysilyl)propyl]disulfide, γ-trimethoxysilylpropyldimethylthiocarbamoyltetrasulfide, and γ-trimethoxysilylpropylbenzothiazyltetrasulfide. The resin composition according to the embodiment may contain two or more kinds of silane coupling agents from the viewpoint of enhancing the adhesion of the primary resin layer to the glass fiber.

A content of the silane coupling agent may be 0.1 parts by mass or more and 5.0 parts by mass or less, 0.2 parts by mass or more and 4.0 parts by mass or less, or 0.3 parts by mass or more and 3.0 parts by mass or less, with respect to 100 parts by mass of the total amount of the resin composition.

The Young's modulus of the primary resin layer may be 0.6 MPa or less, 0.55 MPa or less, 0.5 MPa or less, or 0.4 MPa or less at 23° C. from the viewpoint of enhancing the glass tensile strength of the optical fiber. The lower limit of the Young's modulus of the primary resin layer is not particularly limited, and may be 0.05 MPa or more, 0.1 MPa or more, or 0.2 MPa or more. The Young's modulus of the primary resin layer can be measured by a pullout modulus (POM) method at 23° C. The Young's modulus of the primary resin layer can be adjusted by the kind of urethane (meth)acrylate, the molecular weight of urethane (meth)acrylate, the kind of monomer, the blending amount of monomer, and the like.

The secondary resin layer 15 may be formed using a conventionally known resin composition for a secondary resin layer. The secondary resin layer 15 can be formed by curing a resin composition including, for example, urethane (meth)acrylate, a monomer, and an acylphosphine oxide-based photopolymerization initiator.

The Young's modulus of the secondary resin layer 15 may be 800 MPa or more, 1000 MPa or more, or 1200 MPa or more at 23° C. from the viewpoint of further improving the hot water resistance of the optical fiber. The Young's modulus of the secondary resin layer 15 may be 2000 MPa or less, 1800 MPa or less, or 1500 MPa or less at 23° C. from the viewpoint of forming a resin layer having excellent toughness. The Young's modulus of the secondary resin layer may be measured by a tensile test of the coating resin layer. The Young's modulus of the secondary resin layer can be adjusted by the kind of urethane (meth)acrylate, the molecular weight of urethane (meth)acrylate, the kind of monomer, the blending amount of monomer, and the like.

### EXAMPLES

Hereinafter, the results of evaluation tests using examples and comparative examples according to the present disclosure will be shown, and the present disclosure will be described in more detail. Here, the present disclosure is not limited to these examples.

### [Resin Composition for Primary Resin Layer]

As a photopolymerizable compound, urethane acrylate obtained by reacting polypropylene glycol having a molecular weight of 4000, isophorone diisocyanate, and hydroxyethyl acrylate was prepared. A resin composition P for a primary resin layer was prepared by mixing 60 parts by mass of the urethane acrylate, 30 parts by mass of nonylphenol EO modified acrylate, 7.5 parts by mass of 1,6-hexanediol diacrylate, 1.5 parts by mass of 2,4,6-trimethylbenzoyldiphenylphosphine oxide (TPO N), 0.5 parts by mass of mercaptotrimethoxysilane, and 0.5 parts by mass of ε-caprolactam.

### [Resin Composition for Secondary Resin Layer]

Urethane (meth)acrylate obtained by reacting polypropylene glycol having a molecular weight of 1000, isophorone diisocyanate, and 2-hydroxyethyl acrylate was prepared. A resin composition S for a secondary resin layer was prepared by mixing 60 parts by mass of the urethane (meth)acrylate, 19 parts by mass of isobornyl acrylate, 20 parts by mass of trimethylol propane triacrylate, and 1 part by mass of 2,4,6-trimethylbenzoyl-diphenylphosphine oxide (TPO N).

### [Glass Fiber]

A glass fiber having a diameter of 125 μm and including a core and a cladding, and the cladding includes an inner cladding, a trench, and an outer cladding, and the average chlorine mass concentration in the outer cladding varies, were prepared. The average chlorine mass concentration can be measured by elemental analysis.

### [Production of Optical Fiber]

A primary resin layer having a thickness of 17.5 μm was formed on an outer periphery of the glass fiber using the resin composition P, and a secondary resin layer having a thickness of 15 μm was further formed on the outer periphery thereof using the resin composition S, thereby producing an optical fiber. Test examples 1 to 5 correspond to examples, and test example 6 corresponds to comparative example. The following evaluation was performed on the optical fiber. The results are shown in Table 1.

### (Residual Amount of Acylphosphine Oxide-Based Photopolymerization Initiator)

The residual amount of the acylphosphine oxide-based photopolymerization initiator in the optical fiber was adjusted by the amount of light irradiation when the optical fiber was produced. The optical fiber was immersed in acetone for extraction. The extraction liquid was measured by gas chromatography (manufactured by Shimadzu Corporation, trade name “GC2030”) to determine the amount (% by mass) of the acylphosphine oxide-based photopolymerization initiator.

### (Young's Modulus of Primary Resin Layer)

The Young's modulus of the primary resin layer was measured by the POM method at 23° C. Two points of the optical fiber were fixed with two chuck devices, the coating resin layer (primary resin layer and secondary resin layer) portion between the two chuck devices was removed, and then one of the chuck devices was fixed and the other chuck device was gently moved in the opposite direction of the fixed chuck devices. When a length of the portion of the optical fiber sandwiched between the chuck devices to be moved is L, an amount of movement of the chuck device is Z, an outer diameter of the primary resin layer is Dp, an outer diameter of the glass fiber is Df, a Poisson's ratio of the primary resin layer is n, and a load during movement of the chuck devices is W, the Young's modulus of the primary resin layer was determined from the following formula. Young's modulus (MPa)=((1+n)W/πLZ)×ln(Dp/Df)

### (Glass Tensile Strength)

A bundle of optical fibers was immersed in hot water at 85° C. for 60 days, and the glass tensile strength before and after immersion was evaluated. The glass tensile strength was evaluated to be good or poor by measuring 50% tensile strength. The 50% tensile strength is a tensile strength at which half of the optical fibers to be tested are broken in a tensile test of the optical fibers. In this test example, the tensile test was performed on each optical fiber to be tested at tensile speed of 25 mm/min. With respect to the 50% tensile strength value of the glass tensile strength before immersion, a case where the 50% tensile strength value of the glass tensile strength after immersion was smaller than 80% was evaluated as “C”, a case where the 50% tensile strength value of the glass tensile strength after immersion was 80 to 90% was evaluated as “B”, and a case where the 50% tensile strength value of the glass tensile strength after immersion was larger than 90% was evaluated as “A”.

TABLE 1

| Test Example | 1 | 2 | 3 | 4 | 5 | 6 |
|---|---|---|---|---|---|---|
| Average chlorine mass concentration | 500 | 1000 | 3000 | 5000 | 500 | 50 |
| in the outer cladding | | | | | | |
| (ppm) | | | | | | |
| Residual amount of acylphosphine | 0.1 | 0.1 | 0.1 | 0.1 | 0.3 | 0.3 |
| oxide-based photopolymerization | | | | | | |
| initiator | | | | | | |
| (% by mass) | | | | | | |
| Young's modulus | 0.15 | 0.15 | 0.15 | 0.15 | 0.15 | 0.15 |
| of primary resin layer | | | | | | |
| (MPa) | | | | | | |
| Glass tensile strength | A | A | A | A | B | C |

What is claimed is:

1. An optical fiber comprising:
a glass fiber including a core and a cladding; and
a coating resin layer being in contact with the glass fiber and coating the glass fiber,
wherein the cladding includes an inner cladding covering an outer periphery of the core, a trench covering an outer periphery of the inner cladding, and an outer cladding covering an outer periphery of the trench,
the coating resin layer includes a primary resin layer coating the glass fiber and a secondary resin layer coating the primary resin layer, and
the outer cladding includes quartz glass doped with chlorine, and an average chlorine mass concentration in the outer cladding is 100 ppm or more and 6000 ppm or less.

2. The optical fiber according to claim 1,
wherein the coating resin layer includes a cured product of a resin composition containing a photopolymerizable compound and an acylphosphine oxide-based photopolymerization initiator, and a content of the acylphosphine oxide-based photopolymerization initiator remaining in the coating resin layer is 0.3% by mass or less with respect to a total amount of the optical fiber.

3. The optical fiber according to claim 1,
wherein the primary resin layer includes a cured product of a resin composition containing an acylphosphine oxide-based photopolymerization initiator, a silane coupling agent, an organic base, and a photopolymerizable compound including urethane (meth)acrylate.

4. The optical fiber according to claim 3,
wherein the organic base is δ-valerolactam or ε-caprolactam.

5. The optical fiber according to claim 1,
wherein the primary resin layer has a Young's modulus of 0.6 MPa or less at 23° C.

6. The optical fiber according to claim 2,
wherein the primary resin layer has a Young's modulus of 0.6 MPa or less at 23° C.

7. The optical fiber according to claim 3,
wherein the primary resin layer has a Young's modulus of 0.6 MPa or less at 23° C.

8. The optical fiber according to claim 4,
wherein the primary resin layer has a Young's modulus of 0.6 MPa or less at 23° C.
